(19) United States
(12) Patent Application Publication
(10) Pub. No.: US 2002/0129288 A1
(43) Pub. Date: Sep. 12, 2002

(54) Computing device having a low power secondary processor coupled to a keyboard controller

(76) Inventors: Weng Wah Loh, Bristol (GB); Stephen A. Loughran, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/802,299

(22) Filed: Mar. 8, 2001

(51) Int. Cl. G06F 1/26; G06F 1/32

(52) U.S. Cl. 713/320

(57) ABSTRACT

This abstract has been included pursuant to Section 1.72(b) of the Rules for Patent and Trademark Cases, Title 37 of the Code of Federal Regulations. This abstract is intended only to enable the Patent and Trademark Office and the public to generally determine the nature of the technical disclosure. This abstract is not intended to aid in the interpretation of the scope of any claim.

A portable computing device includes a keyboard controller that receives keystroke information as well as inputs from a graphical pointing device and conveys these to a main central processing unit. The keyboard controller additionally communicates with a battery module through a second interface in order to monitor and control the charging of the module. A low power secondary processor is interfaced to the keyboard controller through the second interface in order to receive keystroke information as well as information from the graphical pointing device. When the keyboard controller is instructed to do so, keystroke and graphical pointing information are conveyed exclusively to the secondary processor, thereby enabling the portable computing device to perform some functions without requiring the main central processing unit to be operational and thus operate in a low power mode.

### BACKGROUND OF THE INVENTION

The invention relates to the field of computing devices and, more particularly, to techniques for reducing the power consumption of portable computing devices.

In a portable computing device, such as a laptop computer, portable paging device, or personal digital assistant, a premium is placed on increasing the length of time that the device can operate while being powered by an internal battery. As this length of time increases, the battery of the portable computing device must be recharged less frequently. In general, the longer the portable computing device can operate in between battery charging events, the more “portable” the device truly is.

In order to increase the battery life of a portable computing device, manufacturers are seeking ways to reduce the power consumption of the computing device. This has led to the investigation into the development of low power central processing units as well as other techniques for low power system design and power management. However, these efforts have not yet resulted in a genuinely low power portable computing device that does not require a complete redesign of the computing device.

Thus, it is highly desirable for a portable computing device to make use of a low power secondary processor that, preferably, does not require a complete redesign of the portable computing device's architecture. Such a low power-consuming device can satisfy the needs of users, who require extended battery life, without requiring the portable computing device manufacturer to completely redesign the device.

### SUMMARY OF THE INVENTION

In the environment in which the invention is practiced, a keyboard controller and battery module communicate with each other using a secondary bus in order to enable the keyboard controller to manage the battery resources used within the portable computing device. According to one aspect of the invention, the keyboard controller additionally communicates with a low power secondary processor by way of the secondary bus. This allows the keyboard controller to transmit user inputs, such as keystrokes and mouse movement information, to the low power secondary processor, thereby allowing the secondary processor to execute functions which are relatively simple and do not require the full operation of the portable computing device's main processor. This, in turn, allows the device to operate in a low-power mode.

These and other aspects of the invention are pointed out with particularity in the appended claims. However, a more complete understanding of the various aspects of the invention may be acquired by reading the description herein, in conjunction with the figures, wherein like reference numerals refer to like elements.

### BRIEF DESCRIPTION OF THE DRAWINGS

FIG. 1 is a block diagram of a portable computing device having a low power secondary processor in accordance with a preferred embodiment of the invention;

FIG. 2 is a block diagram of a method used within a portable computing device having a low power secondary processor in accordance with a preferred embodiment of the invention; and

FIG. 3 is a block diagram of another method used within a portable computing device having a low power secondary processor in accordance with a preferred embodiment of the invention.

### DESCRIPTION OF THE PREFERRED EMBODIMENTS

A portable computing device having a low power secondary processor coupled to a keyboard controller provides a low cost and effective technique of incorporating the low power processor into a portable computing device architecture. By using the keyboard controller to transmit user inputs, such as keystrokes and mouse information, to the secondary processor by way of the keyboard controller's existing interface to the battery module, commands can be received from the keyboard controller without substantial changes to the overall architecture of the portable computing device. This allows a manufacturer to design and produce portable computing devices that beneficially provide users with low power computing resources that enable extended battery life without requiring the manufacturer to completely redesign the portable computing device. A further advantage is a reduction in the time required for the secondary processor to become operational. This advantage is brought about due to a reduction in the required complexity of the secondary processor. This permits the secondary processor to become operational while other portions of the portable computing are inactive.

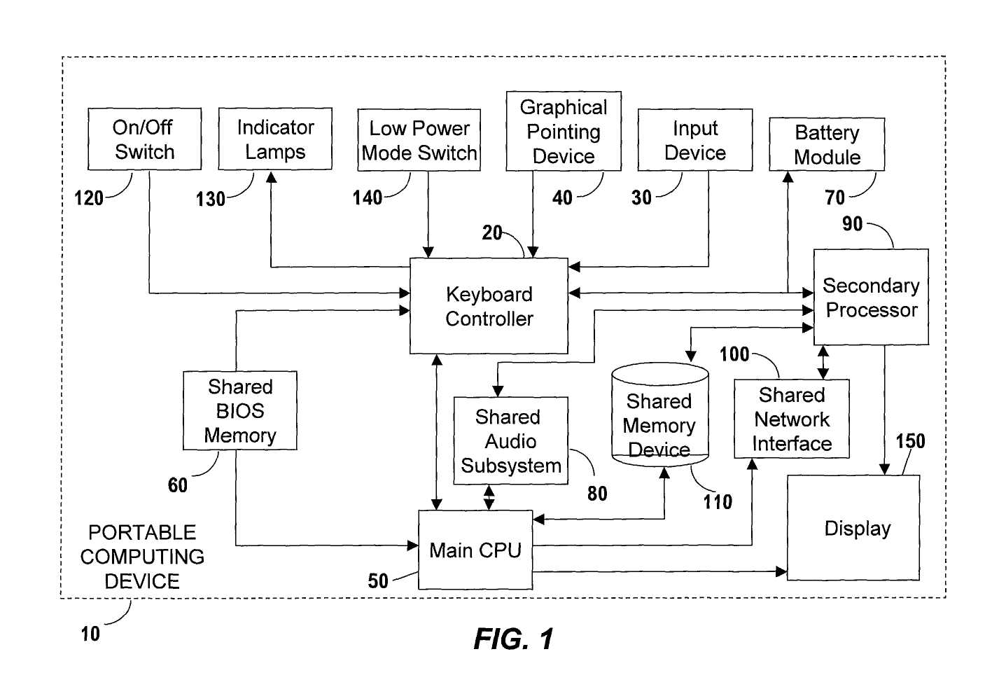

FIG. 1 is a block diagram of a portable computing device (10) having a low power secondary processor in accordance with a preferred embodiment of the invention. In FIG. 1, portable computing device 10 incorporates, among other things, keyboard controller 20. Keyboard controller 20 functions generally to receive inputs from input device 30 and from graphical pointing device 40. It is anticipated that input device 30 represents a keyboard, keypad, or other device that allows a user to input alphanumeric, or other symbolic data to portable computing device 10. Graphical pointing device 40 represents an input device that may include a mouse, track pad, touchpad, or other input device that is manipulated by a user in order to control the position of a pointer on display 150 of portable computing device 10.

Desirably, portable computing device 10 includes main central processing unit (CPU) 50, which communicates with keyboard controller 20 using an internal communications bus used in conventional portable computing devices. Keyboard controller 20 transmits all keystrokes from input device 30 as well as any inputs from graphical pointing device 40 to main CPU 50. In response to these inputs, main CPU 50 executes programs stored in shared memory device 110, which is accessed by main CPU 50 in accordance with conventional techniques.

Keyboard controller 20 further communicates with battery module 70 using a serial bus, which can be an Inter-Integrated Circuit (I2C) bus used in many portable computing devices to provide a communications link between a keyboard controller and a battery module, such as those of portable computing device 10 of FIG. 1. In such portable computing devices, the functions of battery module 70 are managed by a keyboard controller, similar to keyboard controller 20, in order to efficiently recharge battery module 70, and protect the integrity of battery module 70. Keyboard controller 20 also maintains interfaces with other devices that are important to portable computing device 10 such as ON/OFF switch 120, and indicating lamps 130 used to indicate activity and status of the overall functionality of portable computing device 10. Keyboard controller 20 also accepts an input from low power mode switch 140, which commands portable computing device 10 to enter a low power consumption mode by inactivating main CPU 50.

Although shown as a switch, the function of low power mode switch 140 can be performed by any number of switching techniques, such as using inputs from input device 30 or using inputs from graphical pointing device 40, to enable portable computing device 10 to enter or exit a low power state. Under these circumstances, keyboard controller 20 can occasionally scan input device 30 or graphical pointing device 40 to determine if there is sufficient activity to indicate that a user desires to enter or exit the low power state.

In a preferred embodiment of the present invention, secondary processor 90 is interfaced with keyboard controller 20 by way of the I2C bus used to provide a communications channel between keyboard controller 20 and battery module 70. This allows keyboard controller 20 to receive keystrokes from input device 30 and convey the keystroke inputs to main CPU 50 or to secondary processor 90. Desirably, this functionality is brought about through the action of shared basic input/output operating (BIOS) memory 60. Preferably, when portable computing device 10 initializes and executes a power on system test (POST) a data structure exists within shared BIOS memory 60 which includes data objects that instruct keyboard controller 20 to execute a method which enables the keyboard controller to convey keystrokes to either main CPU 50 or to secondary processor 90 depending on whether or not the user has selected a low power consumption mode for the operation of portable computing device 10.

In addition to maintaining an interface with keyboard controller 20, secondary processor 90 possesses an interface to shared memory device 110. Depending on the nature of the information stored within shared memory device 110, secondary processor 90 can query shared memory device 110 for a contact's name and corresponding contact information in response to a query from the user of portable computing device 10. This allows a user to make use of portable computing device 30 as an electronic phone book that displays the contact's information through the functions executed by keyboard controller 20 and secondary processor 90. In accordance with a preferred embodiment of the invention, this search of a database resident within shared memory device 110 and the resulting display of the contact's information can be conducted without main CPU 50, thereby allowing portable computing device 10 to be operated in a low power consumption mode. Diary entries and short notes entered by the user can also be included in shared memory device 110.

Secondary processor 90 also maintains a communications link with shared network interface 100. This allows secondary processor 90 to communicate with a network, such as the Internet, by way of shared network interface 100. It is anticipated that access to shared network interface 100 is shared between secondary processor 90 and main CPU 50 with either processor being capable of exclusively controlling the device as required. This allows secondary processor 90 to execute a World Wide Web browser function in accordance with the type of network interfaced to shared network interface 100. Shared network interface 100 can also be representative of a wireless interface, by way of a Bluetooth transceiver (for example), that provides connectivity to numerous devices. Connection to a network can thus be established through the use of a modem interface, a cellular telephone. Further, shared network interface 100 can interface to a network by way of a wireless application protocol, or through a wireless Ethernet connection. Secondary processor 90 can also run application programs, such as Java applets, or other programs designed to perform a specific task Additionally, secondary processor 90 can maintain a communications link with shared audio subsystem 80, thus allowing the secondary processor to function as a digital music device, such as an MP3 player, and present music to the user without requiring main CPU 50 to become operational. Accordingly, audio is read from a local storage device, such as shared memory device 110 or a compact disc drive (not shown), decoded and conveyed directly to shared audio subsystem 80.

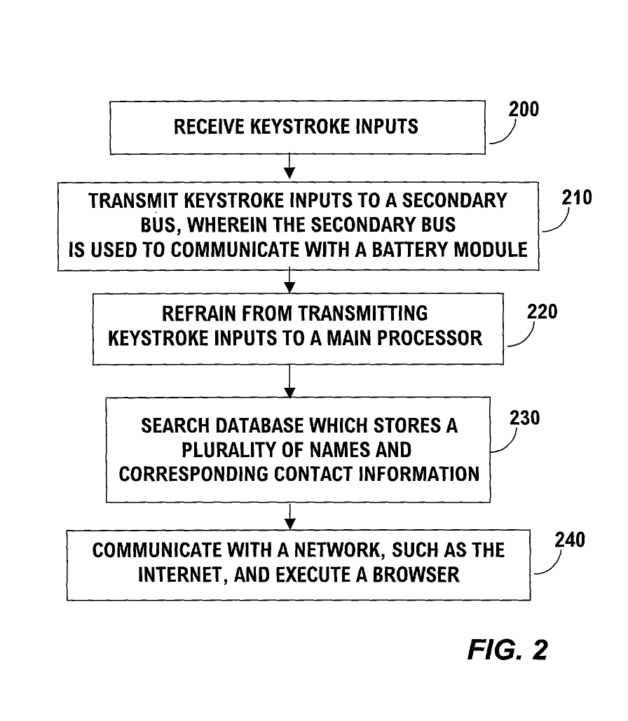

FIG. 2 is a block diagram of a method used within a portable computing device having a low power secondary processor in accordance with a preferred embodiment of the invention. Portable computing device 10 of FIG. 1 is suitable for performing the method of FIG. 2. The method of FIG. 2 begins at block 200 where a keyboard controller receives keystroke inputs. Block 200 can also include the keyboard controller receiving inputs from a graphical pointing device, such as graphical pointing device 40 of FIG. 1. The method continues at block 210 where the received keystroke inputs are transmitted along a secondary bus. It is generally anticipated that the secondary bus is also used to provide a communications link between the keyboard controller and the battery module of the portable computing device.

At block 220, the keyboard controller refrains from transmitting the keystroke inputs to a main processor. The method of FIG. 2 can also include the secondary processor searching a database which stores a plurality of names and contact information, a diary, or short notes, and presenting the results to the user, as in block 230. Further, the method of FIG. 2 can include block 240 where the secondary processor communicates with a network by way of a network interface and executes a World Wide Web browser in the event that the network interface communicates with the Internet. The execution of the World Wide Web browser of block 240 can further include the running an application program such as a Java application or applet.

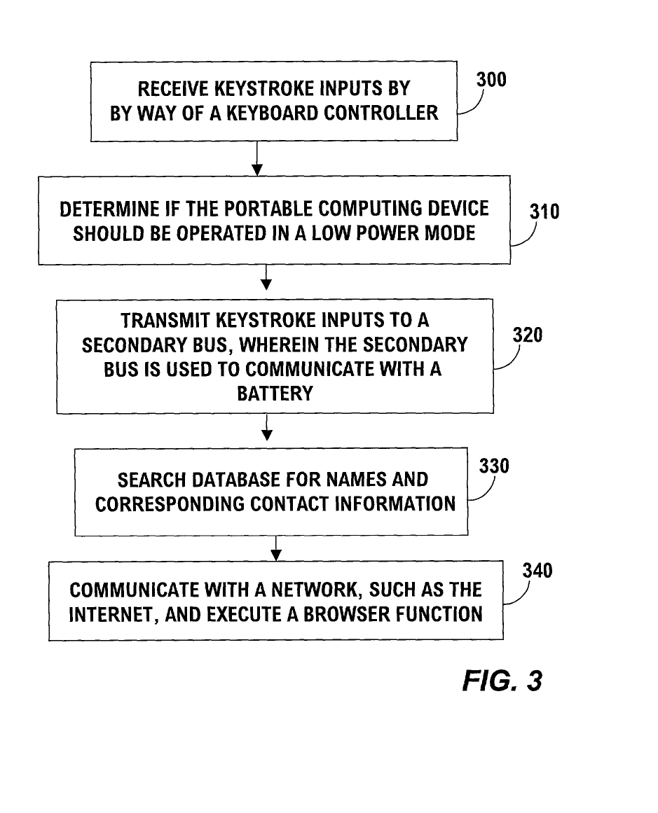

FIG. 3 is a block diagram of another method used within a portable computing device having a low power secondary processor in accordance with a preferred embodiment of the invention. The apparatus of FIG. 1 is suitable for performing the method of FIG. 3. At block 300, a keyboard controller receives a keystroke input from an input device. Block 300 can also include receiving inputs from a graphical pointing device, such as graphical pointing device 40 of FIG. 1. The method of FIG. 3 continues at block 310 where a keyboard controller determines if the portable computing device should be operated in a low power mode. At block 320, keystroke inputs are transmitted to a secondary bus, wherein the secondary bus is also used to communicate with a battery module. Block 320 may include the use of an I2C bus as the secondary bus.

The method continues with the optional search of a database at block 330. In block 330 the database is searched for names and corresponding contact information. The method concludes at block 340 where an Internet browser function is executed. This block may also include running short application programs, such as Java applets. Block 340 can also include loading a web page or running a Java applet in order to provide a user interface for searching the database, thereby operating in place of block 330.

In conclusion, a portable computing device having a low power secondary processor coupled to a keyboard controller provides a low cost technique of incorporating a low power secondary processor into a portable computing device. By attaching the secondary processor to the keyboard controller's existing interface to the battery module, the secondary processor can receive commands from the keyboard. This beneficially provides users with low power computing resources that include extended battery life without requiring the manufacturer to completely redesign the portable computing device. A further advantage is a reduction in the time required for the secondary processor to become operational, which is brought about due to a reduction in the required complexity of the secondary processor.

The foregoing description of the specific embodiments will so fully reveal the general nature of the invention that others can, by applying current knowledge, readily modify and/or adapt for various applications such specific embodiments without departing from the generic concept, and therefore such adaptations and modifications should and are intended to be comprehended within the meaning and range of equivalents of the disclosed embodiments.

It should be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A portable computing device comprising:
a keyboard controller having a first input for receiving keystroke inputs and having an output for conveying said keystroke inputs to a main processor; and
a secondary processor having an interface to said keyboard controller through a secondary bus, said secondary bus also being used to communicate with a battery module, wherein said keyboard controller also conveys said keystroke inputs to said secondary processor through said secondary bus.

2. The portable computing device of claim 1 wherein said secondary bus is an I2C bus.

3. The portable computing device of claim 1 wherein said keyboard controller additionally receives inputs from a graphical pointing device that directs an indicator to move correspondingly about a computer screen.

4. The portable computing device of claim 1 wherein said secondary processor includes an interface to a database that stores a plurality of names and corresponding contact information.

5. The portable computing device of claim 1 wherein said secondary processor includes an interface to a network interface, said secondary processor executing a World Wide Web browsing function in association with said network interface.

6. The portable computing device of claim 1 wherein said secondary processor includes an interface to a shared audio subsystem.

7. A method for operating a portable computing device in a low-power mode, comprising:
receiving keystroke inputs by a keyboard controller;
said keyboard controller transmitting said keystroke inputs to a secondary bus, said secondary bus also being used to communicate with a battery module; and
said keyboard controller refraining from transmitting said keystroke inputs to a main processor, thereby operating said portable computing device in said low-power mode.

8. The method of claim 7 wherein said secondary bus is an I2C bus.

9. The method of claim 7 further comprising said keyboard controller receiving inputs from a graphical pointing device that directs an indicator to move correspondingly about a computer screen of said portable computing device.

10. The method of claim 7 further comprising a secondary processor, which interfaces to said secondary bus, searching a database that stores a plurality of names and corresponding contact information.

11. The method of claim 10 further comprising said secondary processor communicating with a network and executing a World Wide Web browser function in association with said network.

12. The method of claim 11 wherein said secondary processor executes a Java application program.

13. In a keyboard controller, a method for operating a portable computing device, comprising:
receiving keystroke inputs by a keyboard controller;
determining if said portable computing device should be operated in a low-power mode;
said keyboard controller transmitting said keystroke inputs to a secondary bus, said secondary bus also being used to communicate with a battery module; and
said keyboard controller refraining from transmitting said keystroke inputs to a main processor based on said determining action, thereby operating said portable computing device in said low-power mode.

14. The method of claim 13 wherein said secondary bus is an I2C bus.

15. The method of claim 13 further comprising said keyboard controller receiving inputs from a graphical pointing device that directs an indicator to move correspondingly about a computer screen of said portable computing device.

16. The method of claim 13 further comprising a secondary processor, coupled to said secondary bus, searching a database that stores a plurality of names and corresponding contact information.

17. The method of claim 16 further comprising said secondary processor communicating with a network and executing a World Wide Web browser function in association with said network.

18. In a portable computing device which executes a power on system test (POST) program, wherein said POST program accesses a data structure resident in a memory element used by said POST program, wherein said data structure includes a plurality of data objects which instruct a keyboard controller to execute a method which comprises:
determining if said portable computing device is to be operated in a low power mode;
said keyboard controller receiving keystroke inputs;
transmitting said keystroke inputs to a secondary bus, said secondary bus also being used to communicate with a battery module; and
said keyboard controller refraining from transmitting said keystroke inputs to a main processor based on said determining action, thereby operating said portable computing device in said low-power mode.

19. The method of claim 18 wherein said secondary bus is an I2C bus.

20. The method of claim 18 further comprising said keyboard controller receiving inputs from a graphical pointing device that directs an indicator to move correspondingly about a computer screen of said portable computing device.

21. The method of claim 18 further comprising a secondary processor, coupled to said secondary bus, searching a database that stores a plurality of names and corresponding contact information.

22. The method of claim 21 further comprising said secondary processor communicating with a network and executing a World Wide Web browser function in association with said network.
